(19) United States
(12) Patent Application Publication
(10) Pub. No.: US 2005/0081066 A1
(43) Pub. Date: Apr. 14, 2005

(54) Providing credentials

(75) Inventors: Kimmo Lahdensivu, Lempaala (FI); Kimmo Eklund, Turku (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/923,608

(22) Filed: Aug. 20, 2004

(30) Foreign Application Priority Data
Aug. 27, 2003 (FI) FI 20035139

(51) Int. Cl. H04L 9/32

(52) U.S. Cl. 713/202

(57) ABSTRACT

The invention relates to a method and a system for providing credentials for using a service in a first data network. The user logs in to a second data network with a user identifier, which is transmitted from the second network via a gateway to an authentication server, where the user identifier is verified and information on a successful login is sent to the gateway. Information connected to the credentials is stored in connection with the authentication server, in which case the information connected to the credentials is transmitted from the authentication server to the gateway in the login phase. From the gateway the credentials are transmitted to the service in the first data network. The invention also relates to a authentication server to be used in the system, and a gateway.

### CROSS-REFERENCE TO RELATED APPLICATIONS

This application claims priority under 35 USC §119 to Finnish Patent Application No. 20035139 filed on Aug. 27, 2003.

### FIELD OF THE INVENTION

The present invention relates to a method for providing credentials for using a service in a first data network from a second data network, where there is a data transmission connection to the first data network via a gateway, in which method the user logs in to the gateway with a user identifier, said user identifier is transmitted from the second data network via a gateway to an authentication server, wherein the user identifier is verified and information on a successful login is sent to the gateway. In addition, the invention relates to a system, which comprises at least a first data network and a second data network, which are connected to each other with a gateway, means for providing credentials for using a service in the first data network, means for the user to log in to the gateway with a terminal by using a user identifier, means for transmitting said user identifier from the second data network via the gateway to an authentication server, where there are means for verifying the user identifier, and means for sending information to the gateway on a successful login. In addition, the invention relates to an authentication server to be used in a system, which comprises at least a first data network and a second data network, which are connected to each other with a gateway, means for providing credentials for using a service in the first data network, means for the user to log in to the gateway with a terminal by using a user identifier, means for transmitting said user identifier from the second data network via the gateway to the authentication server, where there are means for verifying the user identifier, and means for sending information to the gateway on a successful login. Further, the invention relates to a gateway to be used in a system, which comprises at least a first data network and a second data network, which are connected to each other with said gateway, means for providing credentials for using a service in the first data network, means for the user to log in to the gateway with a terminal by using a user identifier, means for transmitting said user identifier from the second data network via the gateway to an authentication server, where there are means for verifying the user identifier, and means for sending information to the gateway on a successful login.

### BACKGROUND OF THE INVENTION

The user can connect to some local area network, for example, via the Internet network in order to use a service in the local area network. The local area network is, for example, the data network of a company or other community, which in some cases is also referred to as an Intranet. FIG. 1 shows an example of this type of a system, which comprises at least one local area network 1, which comprises one or more services 2 assembled in a remote server 3. In the local area network 1 there is an authentication server 4, which performs user authentication. The user logs in with his/her terminal 5 to a local area network via a second data network 6, such as the Internet. The local area network 1 is connected to the second data network 6 by means of a gateway 7. At both ends of this gateway there is advantageously a firewall 8.1, 8.2, by means of which the outsider access to the local area network 1 is to be prevented. The implementation of the gateway 7 may vary in different applications. The purpose of the gateway 7 is to operate in data transmission between the local area network 1 and the second data network 6 in the system according to this invention, as well as to function as a login means when the user logs in to a system in order to use some service 2.

When the user wants to use some service 2 of a local area network, the operation is, for example, as follows. The user connects with a terminal 5 to the second data network 6 and specifies the address of the authentication server 4 of the local area network as a destination address. After this the terminal 5 and the authentication server 4 communicate with each other for user authentication. In the authentication phase the user typically has to type in a user identifier and a password, on the basis of which the user is identified in the authentication server 4 and it is ensured that the user has the right to log in to use the local area network 1.

The authentication protocol can be, for example, RADIUS (Remote Authentication Dial In User Service), LDAP (Lightweight Directory Access Protocol) or some other protocol suitable for authentication.

After the user has been authenticated and the user's right to use the local area network 1 has been confirmed, the user can begin to use the desired service 2. However, the use of a service usually presupposes that the user inputs the credentials of the service in question, on the basis of which the server, to which the service is installed, can identify the user and verify his/her right to use the service. These credentials are usually not the same as the ones the user uses to log in to the local area network. Thus, the user has to give his/her credentials typically separately for each service, which is inconvenient. In addition, remembering several credentials, such as a user identifier and a password, may be difficult and may require documenting the credentials.

The storage of credentials in an non-encrypted form in the data network 6 or in the gateway 7 is not secure, because outsiders can usually access the second data network 6 as well as the gateway 7, in which case the credentials may become the knowledge of someone who does not have the right to use the local area network 1 or its services 2.

### SUMMARY OF THE INVENTION

It is an aim of the present invention to provide a secure method for storing credentials and providing them for a user for using the services of a local area network. The invention is based on the idea that when the user has been authenticated, information connected to the credentials is transmitted to the user's terminal, in which case when the user moves to use a service of the local area network, the transmitted information is used to determine the credentials. On the basis of this information, the credentials of the user for the service in question are determined and the credentials are transmitted to the service, which can, on the basis of this, verify the user's rights for using the service. The information transmitted in order to determine credentials can comprise credentials, or one or more encryption keys, with which it is possible to decrypt the credentials possibly in an encrypted form.

According to a first aspect of the present invention there is provided a method for providing credentials for using a service in a first data network from a second data network, where there is a data transmission connection to the first data network via a gateway, the method comprising:
performing a login by the user to the gateway with a user identifier, transmitting said user identifier from the second data network via a gateway to an authentication server,
verifying the user identifier in said authentication server,
sending information on a successful login to the gateway,
storing information connected to the credentials in connection with the authentication server,
wherein the method comprises transmitting the information connected to the credentials from the authentication server to the gateway in connection with said login, and
transmitting the credentials from the gateway to said service in the first data network.

According to a second aspect of the present invention there is provided a system, which comprises at least a first data network and a second data network, which are connected to each other with a gateway, means for providing credentials for using a service in a first data network, means for the user to login to the gateway with a terminal by using a user identifier, means for transmitting said user identifier from the second data network via the gateway to an authentication server comprising means for verifying the user identifier, and means for sending information on a successful login to the gateway, wherein information connected to the credentials is stored in connection with the authentication server, the system further comprising means for transmitting information connected to the credentials in connection with login from the authentication server to the gateway, and means for transmitting the credentials from the gateway to said service in the first data network.

According to a third aspect of the present invention there is provided an authentication server to be used in a system, which comprises at least a first data network and a second data network, which are connected to each other with a gateway, means for providing credentials for using a service in the first data network, means for the user to login to the gateway with a terminal by using a user identifier, means for transmitting said user identifier from the second data network via the gateway to an authentication server, where there are means for verifying the user identifier, and means for sending information on a successful login to the gateway, wherein information connected to the credentials is stored in connection with the authentication server, the authentication server further comprising means for sending information connected to the credentials in connection with login to a gateway

According to a fourth aspect of the present invention there is provided a gateway to be used in a system, which comprises at least a first data network and a second data network, which are connected to each other with said gateway;
means for providing credentials for using a service in the first data network;
means for the user to login to the gateway with a terminal by using a user identifier;
means for transmitting said user identifier from the second data network via the gateway to an authentication server comprising means for verifying the user identifier; and
means for sending information on a successful login to the gateway,
wherein information connected to the credentials is stored in connection with the authentication server, the gateway comprising means for receiving information connected to the credentials from the authentication server in connection with login, and means for sending information connected to the credentials to said service in the first data network in connection with login.

The present invention shows advantages over solutions according to prior art. In the system according to the invention it is possible to have in use the credentials of a user for different services in the local area network by means of one user identifier. Thus, the user does not have to separately input service-specific credentials, but the input of one user identifier is enough. This reduces the need to remember different credentials, as well as speeds up and facilitates the beginning of using the services of a local area network. Also, the risk of the credentials being revealed to outsiders is reduced, because the user does not have to store or document several credentials.

### DESCRIPTION OF THE DRAWINGS

In the following, the invention will be described in more detail with reference to the appended drawings, in which

FIG. 1 shows a data system, where the services the users may use are implemented in a local area network,

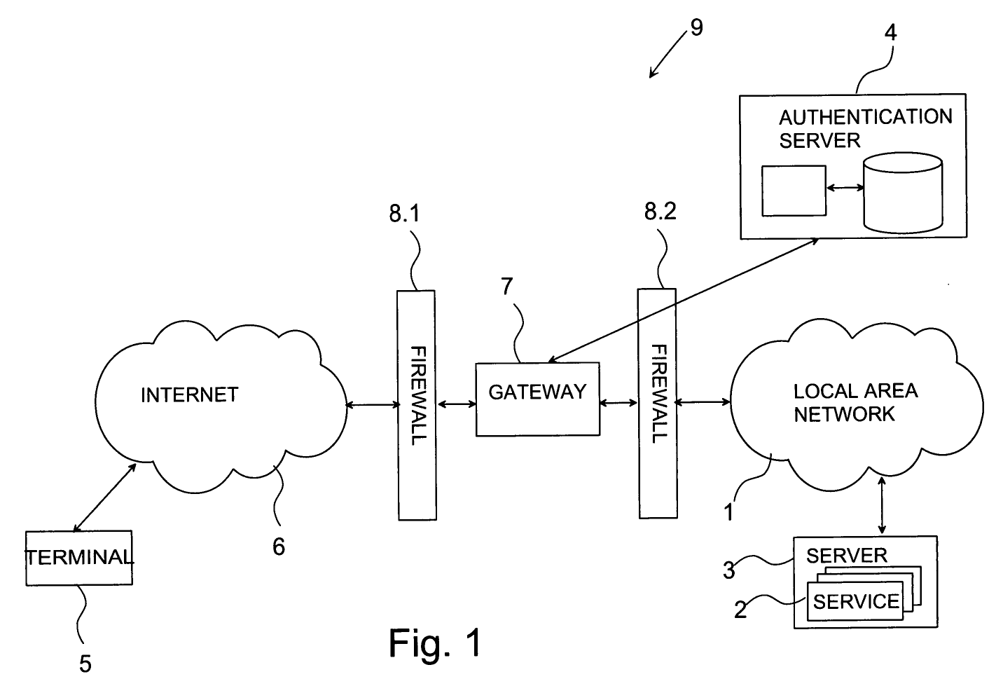

FIG. 2a shows a system according to a first advantageous embodiment of the invention in a reduced chart,

FIG. 2b shows message handling performed in a method according to a first advantageous embodiment of the invention in a reduced chart,

FIG. 3a shows a system according to a second advantageous embodiment of the invention in a reduced chart, and

FIG. 3b shows message handling performed in a method according to a second advantageous embodiment of the invention in a reduced chart.

### DETAILED DESCRIPTION OF THE INVENTION

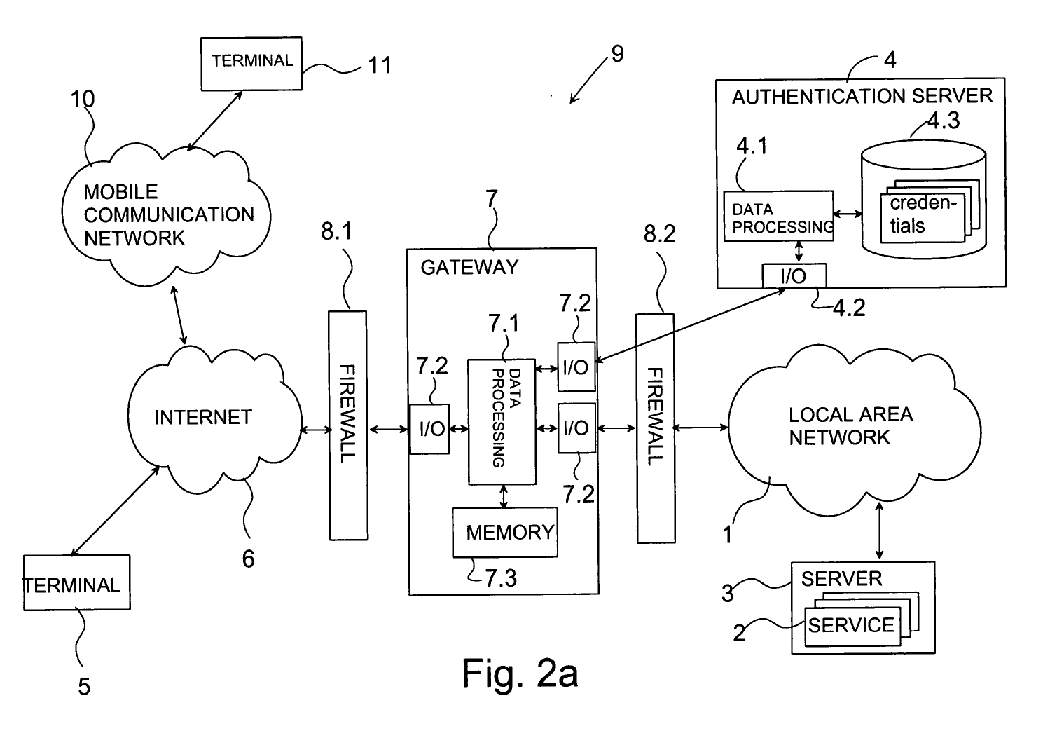

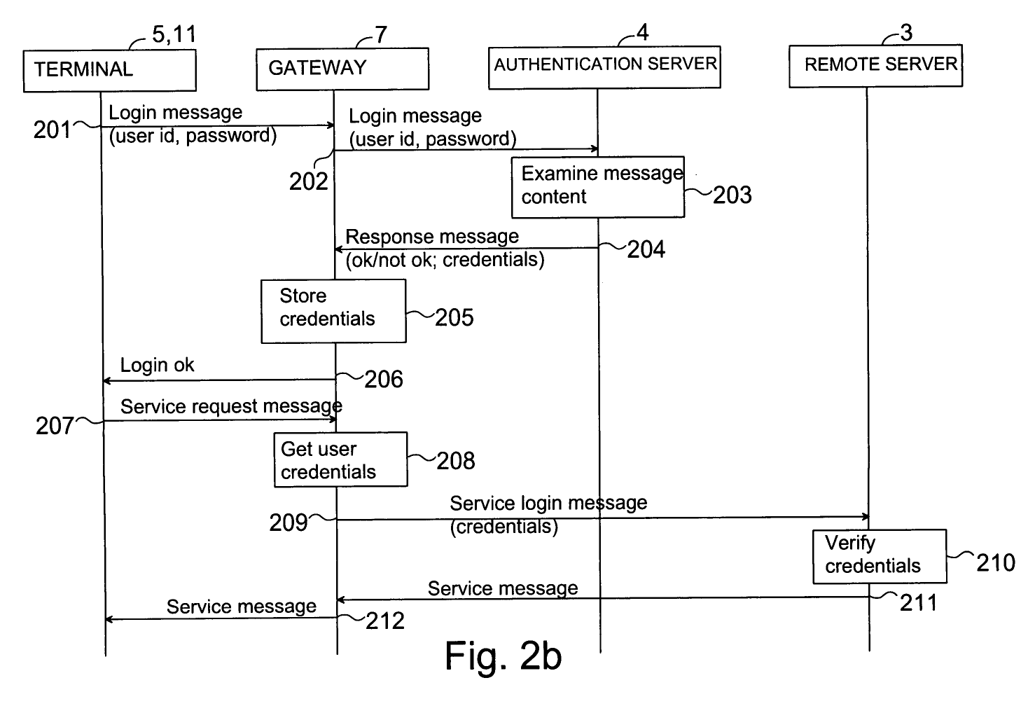

In the following, system 9 according to FIG. 2a will be used as a non-restrictive example in the description of the method and the system according to a first advantageous embodiment of the invention. It comprises a local area network 1, to which is arranged at least one service 2, which can be used from the outside of the local area network 1, for example, via a data network 6. The local area network 1 is connected in a data transmission connection to a data network 6 advantageously by means of a gateway 7. The gateway is advantageously provided with at least data processing means 7.1, data transmission means 7.2 (I/O, Input/Output), as well as a memory 7.3. At both ends of this gateway 7 there is advantageously, in a manner known as such, a firewall 8.1, 8.2 or the like. In addition, the data network 7 is in connection with a wireless data transmission network 10, such as a mobile communication network. Thus the connection to the local area network 1 can be formed also by means of a wireless terminal 11. In the local area network 1 there is an authentication server 4, by means of which the user of a terminal 5, 11 logging in to the local area network 1 can be authenticated. The authentication server is advantageously provided with at least data processing means 4.1, data transmission means 4.2 (I/O, Input/Output) as well as a memory 4.3, for example, for storing a database including user data. A service 2 implemented in the local area network 1 is arranged, for example, in connection with a remote server 3. However, it will be obvious that the authentication server 4 and the remote server 3 do not have to be separate devices, but they can be implemented in one server device as well.

Some non-restricting examples of the services 2, in connection with which the login according to the invention can be applied, are e-mail, an application program installed in the local area network 1, a payment application, a remote control application of the local area network, a calendar, etc.

In the following, let us assume that the user intends to use a service 2 of the local area network 1 with a wireless terminal 11. Thus, the wireless terminal 11, when necessary, logs in to the wireless data transmission network 10 in order to activate a data transmission connection between the wireless data transmission network 10 and the wireless terminal 11. The data transmission connection is advantageously a so-called connectionless connection, such as a packet connection, wherein the data transmission connection does not reserve the resources of the wireless data transmission network for the entire active duration of the connection, but mainly only when data is transmitted over the data transmission connection. An example of such connectionless connection is a packet connection, wherein data is transmitted in packet form only when necessary. For example, in a GSM mobile communication system is implemented a GPRS service (General Packet Radio Service), wherein the packet form data transmission is applied. However, the connection may also be a so-called connection-oriented connection, such as a speech connection, wherein resources are reserved for the connection throughout the entire active time of the data transmission connection.

A secure tunnel is formed between the mobile phone and the gateway server, by means of which all the traffic between the mobile phone and the gateway server is encrypted. The user opens a tunnel session by logging in to the gateway server. The present invention makes it possible that after the tunnel is opened, all the services that are used through the tunnel are at the user's disposal with one login. Thus, with one login it is possible to start a session, during which the gateway server transmits all the credentials required by the services used during the session to the remote server.

After a data transmission connection has been activated for the wireless terminal, the user may begin browsing the data network with, for example, a web browser designed for this purpose. By means of this program the user notifies the system of the address of its local area network or some other identifier of the local area network, on the basis of which the system performs login to the local area network 1. FIG. 2b shows a reduced chart of the message handling for beginning the use of a service used in connection with the method. At this point, data is transmitted between the authentication server 4 or the local area network 1 and the wireless terminal 11 via a gateway 7. For the user of the wireless terminal 11 a login window or the like is advantageously presented, where the user is asked to state his/her user identifier. The user identifier typically comprises a user id and a password. When the user has input this data to the wireless terminal, the user identifier is sent via a data transmission connection to the gateway 7 (arrow 201 in the chart in FIG. 2b). From the gateway 7 the data is transmitted further to the authentication server 4 as an authentication message or the like (arrow 202). In the data transmission between the gateway 7 and the authentication server 4, some protocol suitable for the purpose is used, such as RADIUS or LDAP, in which case the user identifier is transmitted as one or more messages according to the protocol being used. In the authentication server 4 a message or messages are received and the information contained in them is examined (block 203). The authentication server 4 examines from its user database 4.3 e.g. whether a data record corresponding to the user identifier in question exists. If such a record is found, the access rights reserved for the user identifier, such as what services 2 the user in question has the right to use are examined, if necessary. In this advantageous embodiment, the user credentials for those services 2 the user has the right to use have been stored in the database 4.3 of the authentication server as well. Thus, the authentication server 4 sends information on the authentication of the user as well as said credentials to the gateway 7 (arrow 204), where they are stored in a memory 7.1 (FIG. 2a) for using the services, advantageously for the active duration of the data transmission connection (block 205). The gateway 7 concludes, on the basis of the authentication data of the user, whether the authentication server 4 has authenticated the user in question.

If the authentication is performed appropriately, the gateway 7 sends a message of this to the wireless terminal 11 (arrow 206). After this, the use of the service can be started in the wireless terminal 11, in which case a service login message or the like is sent from the wireless terminal 11 to the gateway 7 (arrow 207). The message includes information on the service that is intended to be used. The gateway 7 examines the service and searches the credentials of the user in question for the service to be started (block 208) from its stored credentials. These credentials comprise, for example, the service-specific user identifier and password of the user. When the credentials of the user in question are located in the memory 7.3 of the gateway, the gateway sends a service login message (arrow 209) to that remote server where the service to be used is located. The credentials of the user are transmitted in the login message. The service 2 of the remote server 3 receives the login message and verifies that the credentials are correct (block 210). After this, the remote server 3 sends information according to the service to the gateway 7 (arrow 211), which transmits the information further to the wireless terminal 11 to be presented to the user (arrow 212). The use of the service is now possible. In connection with using the service, data transmission is performed between the wireless terminal 11 and the remote server 3 via a gateway 7. The user does not need to perform the input of credentials. The invention is suitable especially for such systems, where the sending of authentication data is not performed by the terminal, but some other part of the system, which in the above-presented example is the gateway 7 communicating with the authentication server 4.

It should be mentioned here that the database 4.3 of the authentication server 4 is preferably implemented in such a manner that there is no access to the user-specific credentials in the database otherwise than in connection with the login performed by the user. Thus, at least the credentials are stored in an encrypted form and the decrypting is possible only after a correct user identifier, such as a user id and a password, has been input. However, user-specific user identifiers are stored in connection with the authentication server 4 in order for the authentication server to verify that the user attempting login is a user entitled to use the system and that the user identifier has been input correctly.

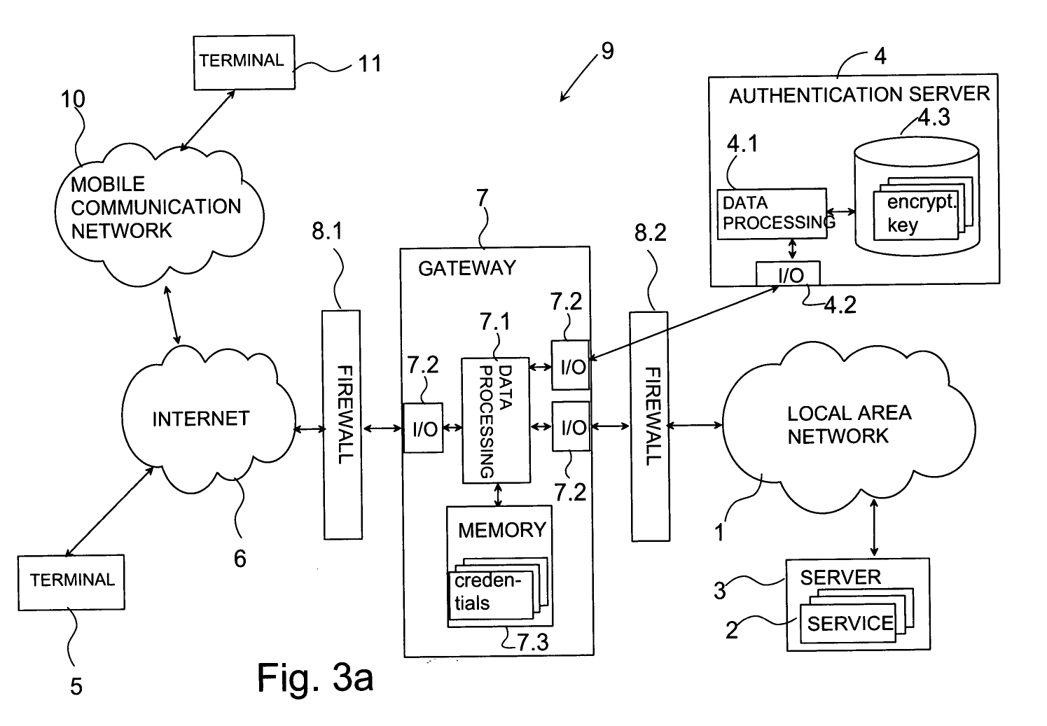

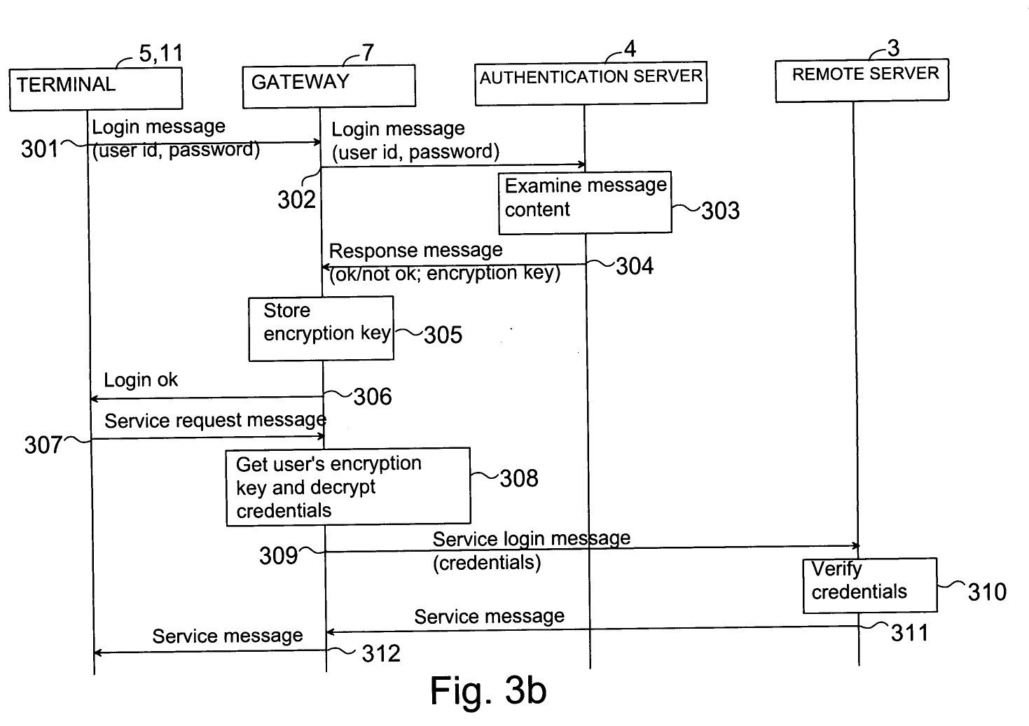

FIG. 3a shows a system according to a second advantageous embodiment of the invention as a reduced chart and FIG. 3b shows the message handling performed in the method according to the second advantageous embodiment of the invention in a reduced manner. This system and method according to the second advantageous embodiment of the invention are mainly in accordance with the first advantageous embodiment of the invention. The most substantial difference is that in this second embodiment the credentials are not stored in connection with the authentication server 4, but in connection with the gateway 7. The credentials are stored in an encrypted form and the key used in decrypting is stored in connection with the authentication server 4.

Let us, in addition, shortly describe the phases of the method. The user notifies the system of the address of its local area network or some other identifier of the local area network, on the basis of which the system performs login to the local area network 1. For the user of the wireless terminal 11, a login window or the like is advantageously presented, where the user is asked to state his/her user identifier. The user identifier typically comprises a user id and a password. When the user has input this data to the wireless terminal, the user identifier is sent via a data transmission connection to the gateway 7 (arrow 301 in the chart in FIG. 3b). From the gateway 7 the data is transmitted further to the authentication server 4 as an authentication message or the like (arrow 302). Some protocol suitable for the purpose, such as RADIUS or LDAP, is used in the data transmission between the gateway 7 and the authentication server 4 in which case the user identifier is transmitted as one or more messages according to the protocol being used. In the authentication server 4 is received a message or messages and the information (block 303) contained in them is examined. The authentication server 4 examines from its user database 4.3 e.g. whether a data record corresponding to the user identifier in question exists. If such a record is found, the access rights reserved for the user identifier, such as what services 2 the user in question has the right to use, are examined, if necessary. In this advantageous embodiment, also the encryption key used in decrypting the user credentials for those services 2 the user has the right to use, has been stored in the database 4.3 of the authentication server. The encryption key is preferably the same for different services, but the invention can also be applied in such a manner that there is a separate encryption key for each service, in which case the encryption key suitable for decrypting the credentials of the service in question is used in decrypting the credentials. Thus, the authentication server 4 sends information on the authentication of the user, as well as said encryption key or encryption keys to the gateway 7 (arrow 304), wherein it/they is/are stored in a memory 7.3 (FIG. 3a) for using the services, preferably for the active duration of the data transmission connection (block 305). On the basis of the authentication data of the user, the gateway 7 concludes whether the authentication server 4 has authenticated the user in question.

If the authentication is performed appropriately, the gateway 7 sends a message of this to the wireless terminal 11 (arrow 306). After this, the use of the service can be started in the wireless terminal 11, in which case a service login message or the like is sent from the wireless terminal 11 to the gateway 7 (arrow 307). The message includes information on the service that is intended to be used. The gateway 7 examines the service and searches the credentials of the user in question for the service to be started from its stored credentials, as well as the encryption key corresponding to the service, after which the gateway performs the decryption of the credentials (block 308). When the credentials of the user in question are located in the memory 7.3 of the gateway and the credentials are decrypted, the gateway sends a service login message (arrow 309) to that remote server 3 where the service to be used is located. The credentials of the user are transmitted in the login message. The service 2 of the remote server 3 receives the login message and verifies that the credentials are correct (block 310). After this, the remote server 3 sends information according to the service to the gateway 7 (arrow 311), which transmits the information further to the wireless terminal 11 to be presented to the user (arrow 312). The use of the service is now possible.

The above-presented second advantageous embodiment of the invention makes it possible to store the credentials into some place not secure as such, such as in connection with the gateway 7. However, in practice, the credentials cannot be easily adapted to an non-encrypted form without a key applicable for decrypting. In view of applying the invention, it is not significant what type of encryption method is used in connection with the invention. The encryption method being used can, however, have an effect mostly on how difficult decryption is without the key for decrypting. Known encryption methods are based either on symmetric encryption, where the same encryption key is used for both the encryption and the decryption, or on asymmetric encryption (e.g. PKI, Public Key Infrastructure), where the encryption key used in encryption is not the same as the key used in decryption.

The present invention can be applied in the existing systems without significant changes in the apparatus of the system. The phases of the method according to the invention can be implemented in the software of the existing apparatus, mainly in the gateway 7 and the authentication server 4.

The authentication server 4 does not necessarily have to be located in the local area network 1, but it is possible to use some other server as the authentication server 4 as well, from which server a data transmission connection can be arranged to the gateway 7 in order to transmit the data required in the user login between the gateway 7 and the authentication server 4.

The present invention is not limited to the above-presented embodiments, but it can be modified within the scope of the appended claims.

1. A method for providing credentials for using a service in a first data network from a second data network, where there is a data transmission connection to the first data network via a gateway, the method comprising:
performing a login by the user to the gateway with a user identifier,
transmitting said user identifier from the second data network via a gateway to an authentication server,
verifying the user identifier in said authentication server,
sending information on a successful login to the gateway,
storing information connected to the credentials in connection with the authentication server,
wherein the method comprises transmitting the information connected to the credentials from the authentication server to the gateway in connection with said login, and
transmitting the credentials from the gateway to said service in the first data network.

2. The method according to claim 1, comprising
storing the service-specific credentials of the user in connection with the authentication server,
transmitting in connection with said login said credentials from the authentication server to the gateway, and
transmitting the credentials connected to said service from the gateway to said service in the first data network.

3. The method according to claim 1, comprising
encrypting the service-specific credentials of the user with an encryption key,
storing in the gateway the service-specific credentials stored with said encryption key,
storing in connection with the authentication server at least one encryption key of service-specific information,
transmitting the encryption key from the authentication server to the gateway in connection with the login,
encrypting the credentials connected to said service with said decryption key in the gateway, and
transmitting the credentials connected to said service from the gateway to said service in the first data network.

4. The method according to claim 3, comprising using the same encryption key in encrypting the credentials of all the services of the same user.

5. The method according to claim 1, comprising performing the login in the gateway, and examining said user identifier in the gateway before getting the information connected to the credentials from the authentication server.

6. The method according to claim 1, comprising storing the information connected to the credentials in connection with the authentication server, protected with a user identifier, wherein the user identifier is used in establishing credentials.

7. The method according to claim 1, wherein in the data transmission between the gateway and the authentication server at least one of the following protocols is used:
RADIUS,
LDAP.

8. A system, which comprises at least a first data network and a second data network, which are connected to each other with a gateway, means for providing credentials for using a service in a first data network, means for the user to login to the gateway with a terminal by using a user identifier, means for transmitting said user identifier from the second data network via the gateway to an authentication server comprising means for verifying the user identifier, and means for sending information on a successful login to the gateway, wherein information connected to the credentials is stored in connection with the authentication server, the system further comprising means for transmitting information connected to the credentials in connection with login from the authentication server to the gateway, and means for transmitting the credentials from the gateway to said service in the first data network.

9. The system according to claim 8, wherein the service-specific credentials of the user are stored in connection with the authentication server, the system further comprising means for transmitting said credentials in connection with login from the authentication server to the gateway, and means for transmitting the credentials connected to said service from the gateway to said service in the first data network.

10. The system according to claim 8, wherein the service-specific credentials of the user have been encrypted with an encryption key, that the service-specific credentials stored with said encryption key have been stored in the gateway, that at least one decryption key of service-specific information is stored in connection with the authentication server, the system further comprising means for transmitting the decryption key in connection with login from the authentication server to the gateway, means for decrypting the credentials connected to said service with said decryption key in the gateway, and means for transmitting the credentials connected to said service from the gateway to said service in the first data network.

11. An authentication server to be used in a system, which comprises at least a first data network and a second data network, which are connected to each other with a gateway, means for providing credentials for using a service in the first data network, means for the user to login to the gateway with a terminal by using a user identifier, means for transmitting said user identifier from the second data network via the gateway to an authentication server, where there are means for verifying the user identifier, and means for sending information on a successful login to the gateway, wherein information connected to the credentials is stored in connection with the authentication server, the authentication server further comprising means for sending information connected to the credentials in connection with login to a gateway.

12. The authentication server according to claim 11, wherein service-specific credentials of the user are stored in connection with the authentication server, wherein in connection with login, the authentication server is adapted to transmit said credentials from the authentication server to the gateway.

13. The authentication server according to claim 11, wherein service-specific credentials of the user are encrypted with an encryption key and stored in connection with the gateway, wherein the authentication server is adapted to store a decryption key used in decrypting the service-specific credentials of the user in connection with the authentication server, and the authentication server is adapted to transmit said decryption key from the authentication server to the gateway in connection with login.

14. A gateway to be used in a system, which comprises
at least a first data network and a second data network, which are connected to each other with said gateway;
means for providing credentials for using a service in the first data network;
means for the user to login to the gateway with a terminal by using a user identifier;
means for transmitting said user identifier from the second data network via the gateway to an authentication server comprising means for verifying the user identifier; and
means for sending information on a successful login to the gateway,
wherein information connected to the credentials is stored in connection with the authentication server, the gateway comprising means for receiving information connected to the credentials from the authentication server in connection with login, and means for sending information connected to the credentials to said service in the first data network in connection with login.

15. The gateway according to claim 14, wherein the service-specific credentials of the user are encrypted with an encryption key and stored in connection with the gateway, the gateway comprising means for receiving the decryption key used in decrypting the service-specific credentials of the user stored in connection with the authentication server, and means for decrypting the service-specific credentials of the user with said decryption key.
